(19) United States
(12) Patent Application Publication
(10) Pub. No.: US 2005/0224312 A1
(43) Pub. Date: Oct. 13, 2005

(54) Portable ball retrieving device

(76) Inventor: Allen G. Farmer, Columbia, IL (US)

Correspondence Address: ASHKAN NAJAFI, P.A., 6817 SOUTHPOINT PARKWAY, SUITE 2301, JACKSONVILLE, FL, 32216, US

(21) Appl. No.: 10/822,294

(22) Filed: Apr. 12, 2004

(51) Int. Cl. G07F 7/00; B65H 1/00; B65G 59/00; G01F 11/28

(52) U.S. Cl. 194/211

(57) ABSTRACT

A device for retrieving balls includes a hollow tube for receiving and dispensing a ball. The device further includes a plurality of flexible mounting brackets so that the device can be selectively mounted along a support surface. An automated coin dispensing system is connected to the tube and includes a sensor aligned with an aperture formed at a predetermined section of the tube. Such a sensor detects when a ball is passing through the tube and sends a signal to a solenoid for causing the coin dispensing system to release a predetermined amount of money.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a ball retrieving device and, more particularly, to a portable ball retrieving device including a money dispensing system.

2. Prior Art

During the practice of sporting activities such as tennis, players sometimes hit a large number of balls, which then lie about on the tennis court or other playing surface. Players must then retrieve the balls and place them in a suitable container for storage until use is again desired.

In addition to squatting or bending down several times to pick up each individual ball, the player has to then walk to a specific location where the balls are being stored, e.g., a tennis bin, for storage and future retrieval of the balls during the ensuing set. This takes many trips across the court since the player can only hold a limited amount of tennis balls at one time. This process is very frustrating and time consuming to the player. It is therefore desirable to provide a device for retrieving and dispensing tennis balls, thereby allowing the user to enjoy more practice time compared to the time spent retrieving the balls.

Accordingly, a need remains for a portable ball retrieving device that overcomes the above-noted shortcomings.

### BRIEF SUMMARY OF THE INVENTION

In view of the foregoing background, it is therefore an object of the present invention to provide a device for retrieving various types of balls. These and other objects, features, and advantages of the invention are provided by a device for retrieving balls during a sporting event. The device includes a hollow tube that has top and bottom openings defining a conduit therebetween for receiving and dispensing a ball respectively. The tube has an aperture formed therein and preferably adjacent to the top opening thereof.

The tube includes an elongated upper portion preferably disposed substantially vertically and rearward of a support surface and an arcuate lower portion integral with the upper portion. Such a lower portion extends outwardly and substantially perpendicularly from the upper portion to thereby become disposed forward of a support surface so that a ball may advantageously be directed therethrough and towards a playing surface.

The device further includes a plurality of flexible mounting brackets that are adjustably engaged about the tube. The plurality of mounting brackets are spaced apart from each other and connectable to a support surface so that the device may be selectively positioned at a predetermined location along a support surface.

The device further includes an automated coin dispensing system that may be connected adjacent to the top opening of the tube. The coin dispensing system includes a housing that has a side wall connected to the tube and preferably spaced between the plurality of brackets. The coin dispensing system further includes a reservoir disposed within the housing that may contain a predetermined amount of money. A sensor also may be disposed within the housing and aligned with the aperture so that the system will detect a ball traveling downwardly through the tube.

Such a sensor has a solenoid and a power supply connected to it. The power supply source causes the solenoid to selectively receive a current therethrough and selectively operate the reservoir. A receptacle may be connected to the housing and preferably disposed therebeneath. The receptacle cooperates with the reservoir so that a user can readily retrieve money therefrom.

Advantageously, the coin dispensing system causes a predetermined amount of money to be ejected therefrom when a ball is passed downwardly through the tube and beyond the aperture. The housing further includes an access door preferably disposed at the top surface thereof and selectively removable so that the coin dispensing system can be refilled and serviced as desired by a user.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a portable ball retrieving device, in accordance with the present invention;

FIG. 2 is a perspective view showing the device of FIG. 1 in a preferred environment;

FIG. 3 is a rear elevational view of the device shown in FIG. 1;

FIG. 4 is a cross-sectional view of the device shown in FIG. 1 taken along line 4-4; and

FIG. 5 is a schematic block diagram of the coin dispensing system shown in FIG. 1.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

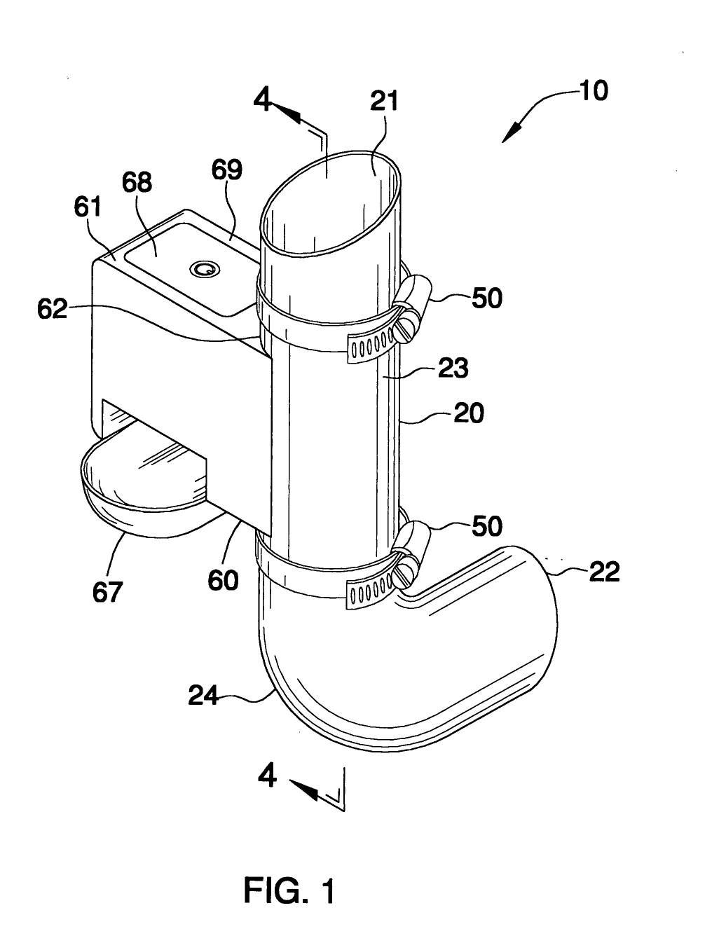

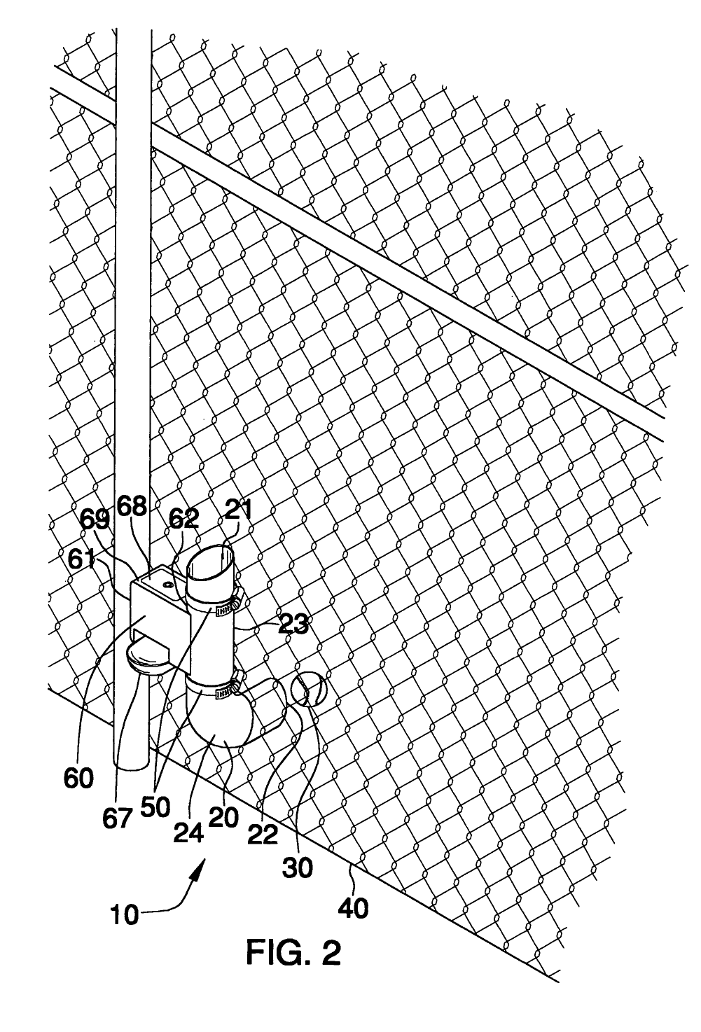

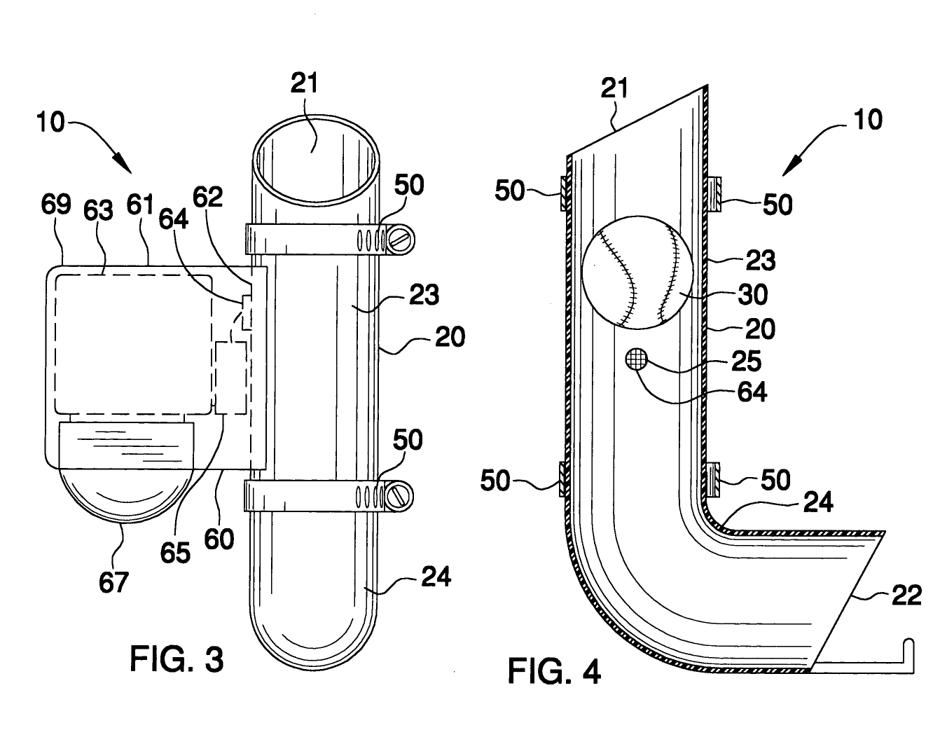

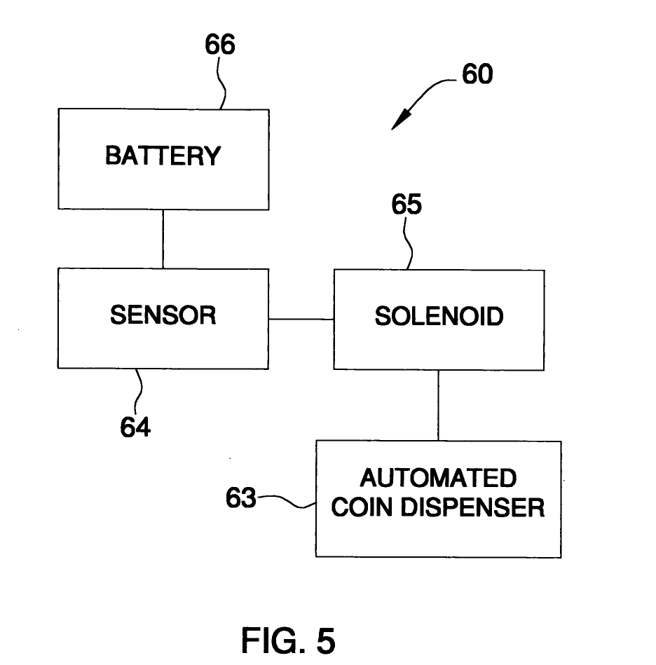

The device of this invention is referred to generally in FIGS. 1-5 by the reference numeral 10 and is intended to provide a portable ball retrieving device. It should be understood that the device 10 may be used to retrieve many different types of sports balls at various sporting events.

Referring initially to FIG. 1, the device 10 includes a hollow tube 20 that has top 21 and bottom 22 openings defining a conduit therebetween for receiving and dispensing a ball 30 respectively. The tube 20 has an aperture 25 formed therein adjacent to the top 21 opening thereof.

The tube 20 includes an elongated upper portion 23 preferably disposed substantially vertically and rearward of a support surface 40 and an arcuate lower portion 24 integral with the upper portion 23. Such a lower portion 24 extends outwardly and substantially perpendicularly from the upper portion 23 to thereby become disposed forward of a support surface 40 so that a ball 30 is advantageously be directed therethrough and towards a playing surface.

The device 10 further includes a plurality of flexible mounting brackets 50 that are adjustably engaged about the tube 20. The plurality of mounting brackets 50 are spaced apart from each other and connectable to a support surface 40 so that the device 10 is selectively positioned at a predetermined location along a support surface 40.

The device 10 further includes an automated coin dispensing system 60 that is connected adjacent to the top opening 21 of the tube 20. The coin dispensing system 60 includes a housing 61 that has a side wall 62 connected to the tube 20 and is spaced between the plurality of brackets 50. The coin dispensing system 60 further includes a reservoir 63 disposed within the housing 61 that contains a predetermined amount of money. A sensor 64 is also disposed within the housing 61 and aligned with the aperture 25 so that the system 60 will detect a ball 30 traveling downwardly through the tube.

Such a sensor 64 has a solenoid 65 and a power supply 66 connected to it. The power supply 66 source causes the solenoid 65 to selectively receive a current therethrough and selectively operate the reservoir 63. A receptacle 67 is connected to the housing 61 and is disposed therebeneath. The receptacle 67 cooperates with the reservoir 63 so that a user can readily retrieve money therefrom.

Advantageously, the coin dispensing system 60 causes a predetermined amount of money to be ejected therefrom when a ball 30 is passed downwardly through the tube 20 and beyond the aperture 25. The housing 61 further includes an access door 68 disposed at the top surface 69 thereof and selectively removable so that the coin dispensing system 60 can be refilled and serviced as desired by a user.

This device 10 is particularly useful at community ball fields, as well as fields where scholastic teams frequently compete. It provides a safer alternative compared to throwing balls 30 over a fence, as the ball would simply drop through the tube 20 and onto the field of play, preventing players from being accidentally struck by a stray ball 30. In addition, the device 10 rewards an individual for returning a ball 30 to the field.

Since the device 10 encourages individuals to return the ball 30 to the field, it reduces the number of balls 30 that are lost or kept by individuals at the game, reducing equipment costs spent by teams through out their season. Advantageously, this device 10 is small, compact and easy to install and remove, allowing it to be stored in a locked storage area, to prevent theft thereof.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A device for retrieving balls during a sporting event, said device comprising:
a hollow tube having top and bottom openings defining a conduit therebetween and for receiving and dispensing a ball respectively, said tube having an aperture formed therein and adjacent said top opening thereof;
a plurality of flexible mounting brackets adjustably engageable about said tube, said plurality of mounting brackets being spaced apart from each other and connectable to a support surface so that said device can be selectively positioned at a predetermined location along a support surface; and
an automated coin dispensing system connected to said tube adjacent said top opening thereof, said coin dispensing system causing a predetermined amount of money to be ejected therefrom when a ball is passed downwardly through said tube and beyond the aperture.

2. The device of claim 1, wherein said tube comprises:
an elongated upper portion disposed substantially vertically and rearward of a support surface; and
an arcuate lower portion integral with said upper portion, said lower portion extending outwardly and substantially perpendicularly from said upper portion to thereby become disposed forward of a support surface so that a ball may be directed therethrough and towards a playing surface.

3. The device of claim 1, wherein said coin dispensing system comprises:
a housing having a side wall connected to said tube and spaced between said plurality of brackets;
a reservoir disposed within said housing and containing a predetermined amount of money;
a sensor disposed within said housing and being aligned with the aperture so that said system will detect a ball traveling through said tube;
a solenoid connected to said sensor and being operably controlled thereby;
a power supply source connected to said sensor and for causing said solenoid to selectively receive a current therethrough and selectively operate said reservoir; and
a receptacle connected to said housing and being disposed therebeneath, said receptacle cooperating with said reservoir so that a user can readily retrieve money therefrom.

4. The device of claim 1, wherein said housing comprises:
an access door disposed at a top surface thereof and being selectively removable so that said coin dispensing system can be refilled and serviced as desired by a user.

5. A device for retrieving balls during a sporting event, said device comprising:
a hollow tube having top and bottom openings defining a conduit therebetween and for receiving and dispensing a ball respectively, said tube having an aperture formed therein and adjacent said top opening thereof, said tube including
an elongated upper portion disposed substantially vertically and rearward of a support surface, and
an arcuate lower portion integral with said upper portion, said lower portion extending outwardly and substantially perpendicularly from said upper portion to thereby become disposed forward of a support surface so that a ball may be directed therethrough and towards a playing surface;
a plurality of flexible mounting brackets adjustably engageable about said tube, said plurality of mounting brackets being spaced apart from each other and connectable to a support surface so that said device can be selectively positioned at a predetermined location along a support surface; and
an automated coin dispensing system connected to said tube adjacent said top opening thereof, said coin dispensing system causing a predetermined amount of money to be ejected therefrom when a ball is passed downwardly through said tube and beyond the aperture.

6. The device of claim 5, wherein said coin dispensing system comprises:
a housing having a side wall connected to said tube and spaced between said plurality of brackets;
a reservoir disposed within said housing and containing a predetermined amount of money;
a sensor disposed within said housing and being aligned with the aperture so that said system will detect a ball traveling through said tube;
a solenoid connected to said sensor and being operably controlled thereby;
a power supply source connected to said sensor and for causing said solenoid to selectively receive a current therethrough and selectively operate said reservoir; and
a receptacle connected to said housing and being disposed therebeneath, said receptacle cooperating with said reservoir so that a user can readily retrieve money therefrom.

7. The device of claim 5, wherein said housing comprises:
an access door disposed at a top surface thereof and being selectively removable so that said coin dispensing system can be refilled and serviced as desired by a user.

8. A device for retrieving balls during a sporting event, said device comprising:
a hollow tube having top and bottom openings defining a conduit therebetween and for receiving and dispensing a ball respectively, said tube having an aperture formed therein and adjacent said top opening thereof, said tube including
an elongated upper portion disposed substantially vertically and rearward of a support surface, and
an arcuate lower portion integral with said upper portion, said lower portion extending outwardly and substantially perpendicularly from said upper portion to thereby become disposed forward of a support surface so that a ball may be directed therethrough and towards a playing surface;
a plurality of flexible mounting brackets adjustably engageable about said tube, said plurality of mounting brackets being spaced apart from each other and connectable to a support surface so that said device can be selectively positioned at a predetermined location along a support surface; and
an automated coin dispensing system connected to said tube adjacent said top opening thereof, said coin dispensing system causing a predetermined amount of money to be ejected therefrom when a ball is passed downwardly through said tube and beyond the aperture, said coin dispensing system including
a housing having a side wall connected to said tube and spaced between said plurality of brackets,
a reservoir disposed within said housing and containing a predetermined amount of money,
a sensor disposed within said housing and being aligned with the aperture so that said system will detect a ball traveling through said tube,
a solenoid connected to said sensor and being operably controlled thereby,
a power supply source connected to said sensor and for causing said solenoid to selectively receive a current therethrough and selectively operate said reservoir, and
a receptacle connected to said housing and being disposed therebeneath, said receptacle cooperating with said reservoir so that a user can readily retrieve money therefrom.

9. The device of claim 8, wherein said housing comprises:
an access door disposed at a top surface thereof and being selectively removable so that said coin dispensing system can be refilled and serviced as desired by a user.
